(19) United States
(12) Patent Application Publication
(10) Pub. No.: US 2023/0312204 A1
(43) Pub. Date: Oct. 5, 2023

(54) PACKAGED FOOD CONCENTRATE WITH BARRIER PROPERTIES PROVIDED BY AN EDIBLE PACKAGING

(71) Applicant: SOCIETE DES PRODUITS NESTLE S.A., Vevey (CH)

(72) Inventors: GERHARD NIEDERREITER, Vevey (CH); NICOLA GALAFFU, Ornex (FR); FANNY CHEVET-DOUELLE, Lausanne 26 (CH); MELANIE BUISSON, Rielasingen-Worblingen (DE); MICHAEL KARLHEINZ HAUSMANN, Auvernier (CH); JULIEN BRAS, St Martin d'uriage (FR); CHRISTINA FRIEDERIKE DANNENBERG, Lausanne (CH)

(21) Appl. No.: 18/043,123

(22) PCT Filed: Aug. 12, 2021
(86) PCT No.: PCT/EP2021/072464

§ 371 Date: Feb. 27, 2023

(30) Foreign Application Priority Data
Aug. 28, 2020 (EP) 20193374.4

(51) Int. Cl. B65D 65/46; A23P 20/10

(52) U.S. Cl. CPC B65D 65/463; A23P 20/105; B65D 65/466

(57) ABSTRACT

The present invention relates generally to the field of packaged food products. In particular, the present invention relates to a packaged food product, wherein the packaging comprises at least one edible packaging layer and the barrier properties of that packaging are mainly provided by that edible packaging layer. For example, the present invention relates to a packaged food concentrate, the packaging comprising an edible primary packaging in contact with the food concentrate and a secondary packing, wherein the edible primary packaging provides the required barrier properties and wherein the edible primary packaging comprises compounds selected from the group consisting of gellans, waxes, whey protein isolate, cellulose, alginates, methylcellulose, hydroxypropylmethyl-cellulose, corn zein, gluten, soy protein, caseinate, chitosan, pectin, carrageenan, or combinations thereof.

### FIELD OF THE INVENTION

The present invention relates generally to the field of packaged food products. In particular, the present invention relates to a packaged food product, wherein the packaging comprises at least one edible packaging layer and the barrier properties of that packaging are mainly provided by that edible packaging layer. For example, the present invention relates to a packaged food concentrate, the packaging comprising an edible primary packaging in contact with the food concentrate and a secondary packing, wherein the edible primary packaging provides the required barrier properties.

### BACKGROUND OF THE INVENTION

Packaging of manufactured food products is a vital part of the food industry today as it ensures food safety, preserves food quality and plays an important role in production processes, in brand communication and in digitalization. Indeed, several studies show that for a large part of consumers the packaging of a product is one key aspect that drives the purchase decision.

One of the main problems associated with packaging in general is the generation of packaging waste. According to Eurostat in 2017, 172.6 kg of packaging waste was generated per inhabitant in the EU.

The industry addresses this issue by embracing the circular economy. In line with this, the European Commission has recently communicated a new Circular Economy Action Plan (COMMUNICATION FROM THE COMMISSION TO THE EUROPEAN PARLIAMENT, THE COUNCIL, THE EUROPEAN ECONOMIC AND SOCIAL COMMITTEE AND THE COMMITTEE OF THE REGIONSA new Circular Economy Action Plan For a cleaner and more competitive Europe, Brussels, 11.3.2020). Accordingly, the EU needs to accelerate the transition towards a regenerative growth model that gives back to the planet more than it takes, advance towards keeping its resource consumption within planetary boundaries, and therefore strive to reduce its consumption footprint and double its circular material use rate in the coming decade.

One step towards achieving this is to provide sustainable food packaging. Such sustainability can be achieved by recyclable and/or biodegradable food packaging. Recently, edible packaging materials have been developed. For example, such edible packaging materials are reviewed in Annu. Rev. Food Sci. Technol. 2010. 1:415-48.

Problematic with edible packaging materials in the food industry is that products packaged in edible food packaging materials on display in stores might be touched by several consumers, before they are actually purchased by one consumer. Consuming a product that was touched by other consumers might be perceived as unpleasant.

Another issue with edible packaging available in the art today is that they are usually used for products with short shelf lives. It would be desirable to have available products packaged in edible packaging that can be used for products with long shelf lives.

One solution to address this is to package the food product in several layers of packaging, so that the edible inner packaging layer, the primary packaging, is not touched by other consumers. In such cases the barrier properties required are provided by the outer packaging layer. However, often, this leads to a problematic recyclability of the outer packaging layer.

Packaging of concentrated food products is in particular challenging as - due to their concentration - they are often hygroscopic, if they contain a fat content, they require a lipid barrier, they need a strong aroma barrier and require a strong oxygen barrier to avoid that the concentrated aroma compounds decay during storage times.

It would therefore be desirable to have available a packaging assembly that is recyclable and/or biodegradable and at least in part edible and that can be used to package concentrated food product for longer storage times in ambient conditions, while avoiding that the edible packaging is touched by consumers other than the purchaser.

Any reference to prior art documents in this specification is not to be considered an admission that such prior art is widely known or forms part of the common general knowledge in the field.

The objective of the present invention was, hence, to improve or enrich the state of the art and in particular to provide the art with a packaging assembly that is recyclable and/or biodegradable and at least in part edible and that has appropriate barrier properties so that it can be used to package concentrated food products for longer storage times in ambient conditions, while avoiding that the edible packaging is touched by consumers other than the purchaser; or to at least provide a useful alternative.

### SUMMARY OF THE INVENTION

The inventors were surprised to see that the objective of the present invention could be achieved by the subject matter of the independent claim. The dependent claims further develop the idea of the present invention.

Accordingly, the present invention provides a packaged food concentrate, the packaging comprising an edible primary packaging in contact with the food concentrate and a recyclable secondary packing, wherein the edible primary packaging provides the required barrier properties and wherein the edible primary packaging comprises compounds selected from the group consisting of gellans, waxes, whey protein isolate, cellulose, alginates, methylcellulose, hydroxypropylmethyl-cellulose, corn zein, gluten, soy protein, caseinate, chitosan, pectin, carrageenan, or combinations thereof.

As used in this specification, the words “comprises”, “comprising”, and similar words, are not to be interpreted in an exclusive or exhaustive sense. In other words, they are intended to mean “including, but not limited to”.

The present inventors have shown that with the packaging assembly described in the present invention it is possible to package a food concentrate, while the edible part of the packaging provides the required barrier properties and a secondary recyclable packaging ensures that the edible packaging is not touched by other consumers than the consumer finally purchasing the food concentrate.

The invention hence relates to a packaging assembly comprising a primary and a secondary packaging, wherein the primary packaging is an edible packaging and provides the required barrier properties for the packaged product and the secondary packaging is a recyclable packaging protecting the primary packaging from being touched, wherein the packaging assembly is intended for packaging food concentrates. The packaging assembly may be to be used for packaging food concentrates.

In a further aspect, the invention relates to a packaged food concentrate, the packaging comprising an edible primary packaging in contact with the food concentrate and a recyclable secondary packing. The edible primary packaging may provide the required barrier properties. The edible primary packaging comprises compounds selected from the group consisting of gellans, waxes, whey protein isolate, cellulose, alginates, methylcellulose, hydroxypropylmethyl-cellulose, corn zein, gluten, soy protein, caseinate, chitosan, pectin, carrageenan, or combinations thereof.

### BRIEF DESCRIPTION OF THE DRAWINGS

FIG. 1 shows an example of an edible primary packaging in an application as wrapper;

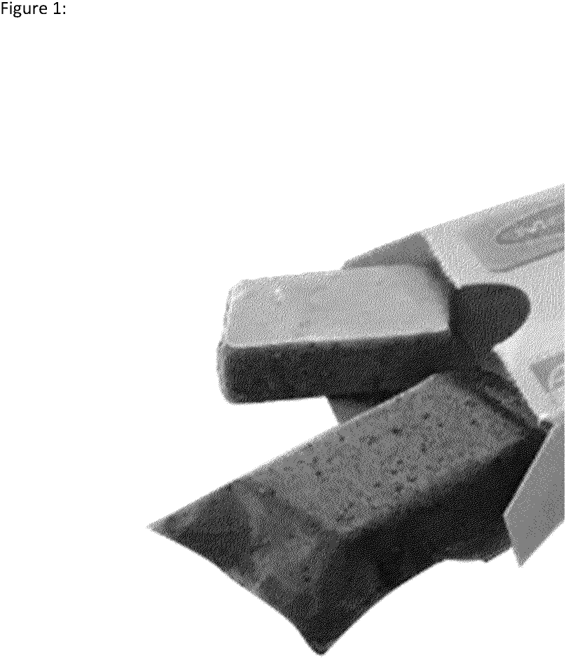

FIG. 2 shows the results of a fat staining test to demonstrate the barrier properties of the edible primary packaging (from left to right: uncoated tablet, alginate coated tablet, beeswax coated tablet);

FIG. 3 shows an example of an edible primary packaging used in a packaged food concentrate in accordance with the present invention, wherein the edible primary packaging comprises seasoning particles.

### DETAILED DESCRIPTION OF THE INVENTION

Consequently, the present invention relates in part to a packaging assembly comprising a primary and a secondary packaging, wherein the primary packaging is an edible packaging providing the required barrier properties for the packaged product and the secondary packaging is a recyclable packaging. The secondary packaging may protect the primary packaging. For example, it may be intended to protect the primary packaging from being touched by consumers other than the consumer consuming the product that is packaged in the primary packaging.

For the purpose of the present invention, a primary packaging is the packaging in direct contact with the packaged product. A secondary packaging is the packaging in contact with the primary packaging. Secondary packaging is often used, for example, for branding display and/or for logistical purposes.

The packaging assembly described in the framework of the present invention may be to be used for packaging food concentrates.

Food concentrates shall be understood for the purpose of the present invention as concentrated food products.

According to Codex Alimentarius, food means any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

Food concentrates may be food products which are to be combined with other ingredients before consumption. For example, food concentrates may be to be reconstituted with liquids, for example water or milk, before consumption.

One example of food concentrates are bouillon tablets. Bouillon tablets may have any shape of form. Today, many bouillon tablets have a shape that resembles cuboids or cubes. Hence, the bouillon tablet may be a bouillon cube, for example.

Bouillon cubes are well known in the art and almost globally available. They may, for example, comprise salt, sugar, oil and/or fat, flavors, vegetables, and spices.

A conventional way of manufacturing bouillon tablets or cubes comprises mixing powdered bouillon components with fat and no or only little amounts of oil, and pressing the mix into a tablet or cube form. The presence of fat, and in particular of oil that is liquid at ambient temperature is challenging for any food packaging as the lipids may penetrate the packaging. In addition, the concentrated nature of the bouillon product is hygroscopic posing a further challenge to the barrier properties of the packaging.

The bouillon tablet may be a hard bouillon tablet, a soft bouillon tablet of a gel-like bouillon tablet, for example.

The food concentrate may also be a spice or a spice mixture, for example a dehydrated spice mixture. It may also be a powdered soup product, such as a dehydrated soup product.

The present invention further relates to a packaged food concentrate, the packaging comprising an edible primary packaging and a recyclable secondary packing, wherein the edible primary packaging provides the required barrier properties.

The edible primary packaging may be in contact with the food concentrate.

The inventors were able to propose an edible primary packing that provides the required barrier properties for packaging the concentrated food product. This has the advantage, that the secondary packaging, which may be non-edible, may be chosen from a wide range of materials, including materials that are very well recyclable and/or biodegradable as the secondary packaging does not have to deliver essential barrier properties. For example, the secondary packaging material may be a monolayer packaging material. This allows to avoid multilayer packaging materials, which are often challenging to recycle.

For example, the secondary packaging material may be a plastic film, paper-based or paper.

The barriers may be selected from the group consisting of a grease barrier, an aroma barrier, an oxygen barrier and/or a water barrier.

Oxygen barrier properties are usually measured as oxygen transmission rate (OTR). Water barriers are usually measured as water vapor transmission rate (WVTR).

A grease barrier is important for concentrated food products that comprise oil and/or fat. In particular if the oil or fat is liquid at room temperature it has the tendency to penetrate the packaging, making the product less appealing, and an edible packaging possible less pleasant to consume.

Aroma barriers are key to concentrated food products, as they help to ensure that the food product does not loose flavor during storage, which is often for longer times at ambient temperatures. It also ensures that the food product does not take up other flavors from the surroundings.

Water barriers are important if the concentrated food product is hygroscopic, which is usually the case. Without a sufficient water barrier, the food product might take up water from the surroundings altering texture and possibly available storage time.

Oxygen barriers help to prevent that the concentrated food product is exposed to oxygen, leading to oxidation, possibly altering taste and appearance of the food product.

Hence the barrier properties provided by the edible primary packaging may be selected from the group consisting of an oil and grease barrier, moisture barrier or an oxygen transmission barrier. The oil and grease barrier may have a maximum score of 1 when tested according to Lange et al. (Packag. Technol. Sci. 2002; 15: 65-74) and/or a WVTR of at least 4.5 g/m2/day and/or an OTR of at least 25 cc/m2/day/atm (23° C., 50%RH).

Edible food packaging is well known in the art. Some edible food packaging types are reviewed in Annu. Rev. Food Sci. Technol. 2010. 1:415-48. However, to the inventor’s best knowledge it was never taught nor suggested that such edible packaging could be used to package concentrated food products while providing the required barrier properties.

For example, the edible primary packaging may comprise compounds selected from the group consisting of gellans, whey protein isolate, cellulose, alginates, waxes, methylcellulose, hydroxypropylmethylcellulose, corn zein, gluten, soy, caseinate, chitosan, pectin, carrageenan, or combinations thereof, preferably natrium alginate, beeswax, cellulose, methylcellulose, hydroxypropylmethylcellulose, corn zein, gluten, soy protein, caseinate, carrageenan, or combinations thereof, preferably natrium alginate, beeswax, cellulose, methylcellulose, hydroxypropylmethylcellulose, caseinate, or combinations thereof.

In an embodiment the edible primary packaging comprises the compounds in an amount between 0.1 to 2 wt% (based on the food concentrate), preferably between 0.1 to 1.5 wt%, preferably between 0.1 to 1 wt%, preferably between 0.2 to 2 wt%, preferably 0.2 to 1.75 wt%, preferably between 0.2 to 1.5 wt%, preferably between 0.2 to 1 wt%.

For example, the present inventors have prepared a prototype of a packaged food concentrate that achieves the objective of the present invention with a primary packing comprising compounds selected from the group consisting of natrium alginates.

A further prototype achieving the objective of the present invention can be prepared using a primary packaging comprising natrium alginate and methylcellulose. Accordingly, the edible primary packaging may comprise compounds selected from the group consisting of natrium alginate and methylcellulose. For example, alginate and methylcellulose may be used in a weight ratio in the range of about 5:1 - 15:1, of about 8:1 to 12:1, or of about 10:1.

Advantageously, the edible packaging described in the framework of the present invention may be sugar free. This has the advantage that the edible packaging is healthier to consume and does not impart an unwanted sweet taste to the packaged concentrated food product, if it is consumed together with the primary packaging.

Hence, in one embodiment of the present invention, the edible primary packaging may be sugar free.

In particular for bouillon products or dehydrated soups, for example, it may be preferred if the edible primary packaging was water soluble. This has the advantage that the packaged food product can be added to food preparations in its primary packaging. The prototypes prepared by the present inventors have edible primary packaging that is dissolvable in water, for example in hot water. Accordingly, in one embodiment of the present invention, the edible primary packaging may be water soluble.

The food product may be packaged in the primary packaging by any process known in the art. For example, the food concentrate may be packaged in the edible primary packaging by a process comprising the steps of preparing a solution containing the constituents of the edible packaging, applying the solution onto the food concentrate and drying the edible packaging.

For example, in a first step a mixture may be prepared comprising the constituents of the primary packaging and a solvent. The solvent may be water based. It may comprise water, ethanol, isopropylalcohol, acetone, glycerol or combinations thereof, preferably water, ethanol or a combination thereof.

In an embodiment the solution containing the constituents of the edible packaging further comprises ethanol in an amount between 5 to 40 wt% (based on the total amount of solution), preferably between 10 to 40 wt%, preferably between 5 to 30 wt%, preferably between 10 to 30 wt% (based on the total amount of solution). By using ethanol in the solution containing the constituents of the edible packaging fast drying results have been achieved. This leads to a high manufacturing output, with such a composition. Complete drying of the composition is achieved within less than 60 seconds, and in some cases within less than 30 seconds.

For an optimal edible packaging to result it is important that the constituents of the edible packaging are mixed as homogenously as possible. For example, the mixture may be homogenized to ensure optimal mixing.

Air should be removed from the mixture, as air bubbles in the mixture might result in structural weaknesses of the resulting primary packaging, leading possibly to reduced barrier properties. The air may be removed by allowing the mixture to sit for a longer time to allow the air bubbles to rise and be eliminated from the mixture. This process may be accelerated, for example, by applying a vacuum.

The mixture may then be applied to the food product by dipping the food concentrate into the mixture and/or by spraying the mixture onto the food concentrate.

Alternatively, the mixture may be applied to a surface, for example a mold.

After the application, the mixture is dried. Drying may be supported by ventilation, a vacuum, hygroscopic compounds and/or by heating, for example.

If the mixture was not dried directly on the food concentrate, it may then be used to package the food concentrate.

The food concentrate may be selected from the group consisting of pressed food concentrates or jellified food concentrates. The food concentrate may be a food concentrate to be reconstituted in water, for example. Further, for example, the food concentrate may be a stock cube or a spice composition.

The secondary packaging may be used to protect the primary packaging. For example, the secondary packaging may be used to protect the primary packaging from being exposed to manual contact to consumers that may not consume the product. It may also be used to convey brand messaging and consumer information. It may further be used to ensure easy shipping and handling, for example by comprising more than one food concentrate packaged in a primary packaging.

For example, the secondary packaging may be wrapped around the food concentrate packaged in the primary packaging. Further for example, the secondary packaging may be fold wrapped around the food concentrate packaged in the primary packaging.

As the barrier properties are provided by the primary packaging, the secondary packaging may have a simple structure allowing easy recycling and/or biodegradation.

It may be desired if the secondary packaging is a monolayer packaging and/or a monomaterial packaging. For example, the secondary packaging may comprise oriented polypropylene (OPP), oriented polyethylene (OPE), polyethylene terephthalate (PET), paper, molded pulp or combinations thereof.

In some embodiments, a paper based and/or a paper secondary packaging may be preferred as such paper-based packaging is easily recyclable with the paper stream. Paper recycling is widely available. Hence, in one embodiment of the present invention the secondary packaging is made from paper.

The secondary packaging may be recyclable and/or biodegradable.

According to the European Commission under reference to Pure Applied Chemistry 84 (2), pp. 377-410, biodegradability is understood as the capability of the material to be converted into CO2 under the action of micro-organisms. This property may be measured with a laboratory standard test method: the EN 14046 (also published as ISO 14855: biodegradability under controlled composting conditions). In order to show complete biodegradability, a biodegradation level of at least 90% must be reached in less than 6 months. The norm EN 13432 is a harmonized norm.

A material can be considered recyclable, if it can be subjected to recycling. According to the DIRECTIVE 2008/98/EC OF THE EUROPEAN PARLIAMENT AND OF THE COUNCIL ‘recycling’ means any recovery operation by which waste materials are reprocessed into products, materials or substances whether for the original or other purposes. It includes the reprocessing of organic material but does not include energy recovery and the reprocessing into materials that are to be used as fuels or for backfilling operations.

It is well known that packaged food concentrates are usually coded by printing an ink on the packaging material. Due to different technical reasons including drying time of the ink and abrasion during further processing steps, the printing on the packaging material is commonly done after wrapping the packaged food concentrates. As the ink printing is done on a packaged food product, which has direct contact to the food product, the ink has to be food compliant. New methods have been proposed for this printing, one of which is described in EP3452374A1. Accordingly, in one embodiment of the present invention, a laser code is visibly applied to the outside of the secondary packaging.

Those skilled in the art will understand that they can freely combine all features of the present invention disclosed herein. In particular, features described for the product of the present invention may be combined with the use of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### Example 1: Spray Coating of a Bouillon Tablet With a Low Viscosity Alginate Solution

An aqueous solution (at room temperature) containing 15% ethanol absolute and 2.5% of plasticizer was prepared in a beaker. The dry ingredients including sodium alginate (1.7%) and methyl cellulose (0.17%) were transferred into the solution and stirred with a spatula to humidify the dry ingredients. The mixture was then homogenized with an Ultra Turrax for approximately 3 minutes.

MAGGl® vegetable bouillon tablets (10 g) were used for this evaluation. The spraying solution was transferred into the container cup of a spraying gun and sprayed with the gun onto each side of the bouillon tablet with a pressure of 4 bar. The test was conducted at room temperature. The successfully coated bouillon tablet was then dried in an oven with a temperature of 90° C. for 10-15 min. The coating and drying step was repeated one more time. As a result, the formulation was sprayable and produced a uniform glossy and thin coating layer.

In order to test the water solubility of the coating, a qualitative dissolution test was performed on the coated tablet and on an uncoated reference tablet. Each tablet was transferred into a beaker and 200 ml of boiling water was added. The coated tablet successfully dissolved in water with no considerable differences in reconstitution behavior compared to the uncoated bouillon tablet.

Grease barrier properties of the coating were tested by a qualitative fat staining test. Commercial copy paper was placed on a blotting paper with squares. A glass plate was put underneath as a support. The coated bouillon tablet and an uncoated tablet as a reference were placed on the copy paper. The plates were subsequently transferred into an oven and exposed to a temperature of 50° C. over 68 hours.

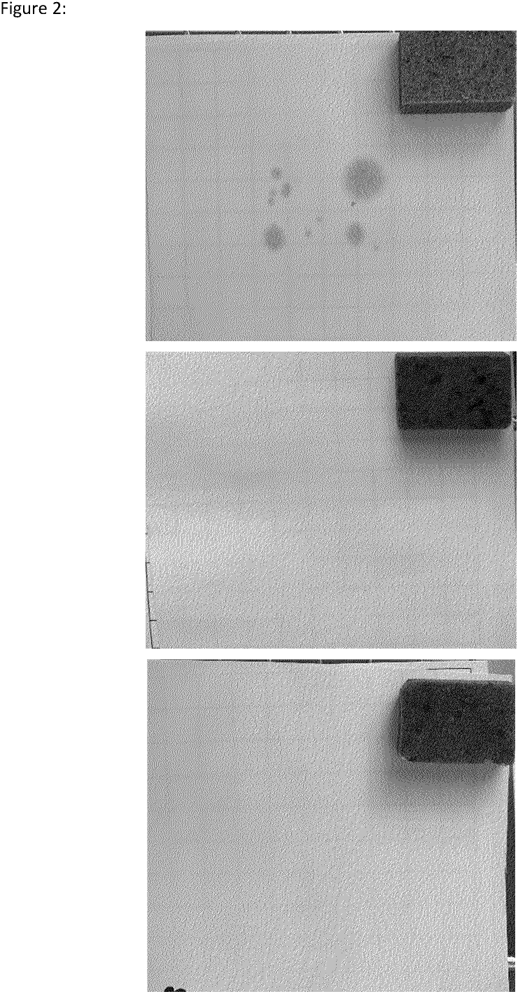

After removing the tablet from the paper, the paper below the uncoated bouillon tablet exhibited clear fat staining while the paper of the coated tablet was unstained (see FIG. 2). This result shows that the coating provides an excellent grease barrier at conditions even above ambient temperatures.

### Example 2: Spray Coating of a Bouillon Tablet With a Low Viscosity Beeswax Solution

In a second experiment a solution comprising ethanol and beeswax (Total solids: 22-23%) was sprayed on a vegetable bouillon tablet with the same procedure as explained within example 1. A final heat treatment at 120° C. was performed on the coated tablet in order to liquify the wax and close any remaining pores on the surface. Similar to example 1, the obtained coating was homogenous and glossy covering the tablet with a thin layer.

Similar to example 1, a water solubility test as well as a grease barrier test were performed on the coated tablet with the same procedure as described in example 1. The coated tablet successfully dissolved in water with no considerable differences in reconstitution compared to the uncoated bouillon tablet.

In terms of grease barrier, the coated tablet shows significant improvements. No fat staining was observed on the paper below the coated tablet. As for example 1, it can be concluded that the beeswax coating shows grease barrier properties even above ambient temperature conditions.

FIG. 2 shows the result of the fat staining test (from left to right: Uncoated tablet, alginate coated tablet, beeswax coated tablet)

### Example 3: Continuous Double Spray Coating of a Bouillon Tablet With a Casein Solution

In this experiment, the coating solution was applied onto the food concentrate using a continuous pilot line set up with double spraying system and hot air drying station.

An aqueous solution (at room temperature) containing 15% ethanol absolute was prepared in a container. Dry casein (15%) was transferred into the solution and stirred during 15 minutes at 60° C. until the casein particles were dissolved.

MAGGI® vegetable bouillon tablets (10 g) were used for this evaluation. The spraying solution was transferred into the double spraying system able to spray any substrate from the top and bottom. The cubes were placed on a metal wire belt and sprayed from all sides from the top and bottom nozzle. Subsequently, the cubes were transferred onto a 2^{nd} belt and dried via a fan with dry, hot air (humidity: 10-15%, temperature: 130° C.). As a result, the formulation was sprayable and produced a uniform glossy and thin coating layer.

Grease barrier properties of the coating were tested by a qualitative fat staining test. Commercial copy paper was placed on a blotting paper. A glass plate was put underneath as a support. The coated bouillon tablet was placed on the copy paper. The plates were subsequently transferred into an oven and exposed to a temperature of 80° C. over 48 hours.

After removing the coated tablet from the paper, the paper below the uncoated bouillon paper remained unstained. This result shows that the coating provides an excellent grease barrier at conditions even above ambient temperatures and when produced on a continuous line.

### Example 4: Continuous Dipping and Spreading Coating Technology Using a Casein Solution as Coating Agent and Bouillon Tablet as Substrate

In this experiment, the coating solution was applied onto the food concentrate using a continuous pilot line set up composed of a hybrid dipping and spreading technology and a subsequent blow off and hot air drying station.

An aqueous solution (at room temperature) containing 15% ethanol absolute was prepared in a container. Dry casein (15%) was transferred into the solution and stirred during 15 minutes at 60° C. until the casein particles were dissolved.

MAGGI® vegetable bouillon tablets (10 g) were used for this evaluation. The dipping solution was transferred into the dipping bath container in which brushes were entering in a rotating motion. The cubes were manually transferred into the dipping bath and while moving towards the exit were brushed continuously with additional coating solution. Subsequently, the cubes were transferred onto a belt and excess coating was removed via a blow off section before entering the hot air drying section (Humidity: 10-15%, temperature: 130° C.). The obtained coated cubes exhibited a homogenous, glossy coating layer.

Grease barrier properties of the coating were tested by a qualitative fat staining test. Commercial copy paper was placed on a blotting paper. A glass plate was put underneath as a support. The coated bouillon tablet was placed on the copy paper. The plates were subsequently transferred into an oven and exposed to a temperature of 80° C. over 48 hours.

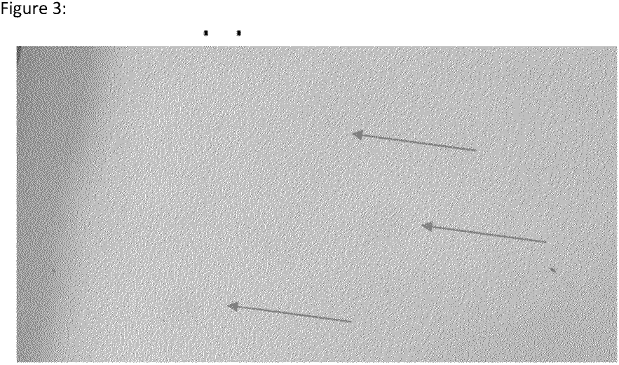

After removing the coated tablet from the paper, the paper below the uncoated bouillon paper remained unstained (see FIG. 3). This result shows that the coating provides an excellent grease barrier at conditions even above ambient temperatures and when produced on a continuous line.

1. Packaged food concentrate, the packaging comprising an edible primary packaging in contact with the food concentrate and a recyclable secondary packing, wherein the edible primary packaging provides the required barrier properties and wherein the edible primary packaging comprises compounds selected from the group consisting of gellans, waxes, whey protein isolate, cellulose, alginates, methylcellulose, hydroxypropylmethyl-cellulose, corn zein, gluten, soy protein, caseinate, chitosan, pectin, carrageenan, and combinations thereof.

2. Packaged food concentrate in accordance with claim 1, wherein the barrier properties are selected from the group consisting of an oil and grease barrier with a maximum score of 1 when tested according to Lange et al. (Packag. Technol. Sci. 2002; 15: 65-74), a WVTR of at least 4-5 g/m²/day, and an OTR of at least 25 cc/m²/day/atm (23° C., 50%RH).

3. Packaged food concentrate in accordance with claim 1, wherein the edible primary packaging comprises compounds selected from the group consisting of natrium alginate, beeswax, cellulose, methylcellulose, hydroxypropylmethylcellulose, corn zein, gluten, soy protein, caseinate, carrageenan, and combinations thereof.

4. Packaged food concentrate in accordance with claim 1, wherein the edible primary packaging comprises the compounds in an amount between 0.1 to 2 wt% (based on the food concentrate).

5. Packaged food concentrate in accordance with claim 1, wherein the edible primary packaging is sugar free and/or comprises seasoning particles.

6. Packaged food concentrate in accordance with claim 1, wherein the edible primary packaging is water soluble.

7. Packaged food concentrate in accordance with claim 1, wherein the food concentrate is packaged in the edible primary packaging by a process comprising the steps of preparing a solution containing the constituents of the edible packaging, applying the solution onto the food concentrate and drying the edible packaging.

8. Packaged food concentrate in accordance with claim 7, wherein the solution containing the constituents of the edible packaging further comprises ethanol in an amount between 5 to 40 wt% (based on the total amount of solution).

9. Packaged food concentrate in accordance with claim 1, wherein the food concentrate is selected from the group consisting of pressed food concentrates or jellified food concentrates.

10. Packaged food concentrate in accordance with claim 1, wherein the food concentrate is a food concentrate to be reconstituted in water.

11. Packaged food concentrate in accordance with claim 1, wherein the food concentrate is a stock cube or a spice composition.

12. Packaged food concentrate in accordance with claim 1, wherein the secondary packaging is wrapped around the food concentrate packaged in the primary packaging.

13. Packaged food concentrate in accordance with claim 1, wherein the secondary packaging is selected from the group consisting of oriented polypropylene (OPP), oriented polyethylene (OPE), polyethylene terephthalate (PET), paper, molded pulp and combinations thereof.

14. Packaged food concentrate in accordance with claim 1, wherein the secondary packaging is made from paper.

15. Packaged food concentrate in accordance with claim 1, wherein the secondary packaging is biodegradable.
